(19) United States
(12) Patent Application Publication
(10) Pub. No.: US 2006/0038863 A1
(43) Pub. Date: Feb. 23, 2006

(54) Refillable chemical cartridge for photoprocessing equipment

(75) Inventors: Ralph L. Piccinino JR., Rush, NY (US); Diana C. Petranek, Hilton, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/920,958

(22) Filed: Aug. 18, 2004

(51) Int. Cl. B41J 2/175

(52) U.S. Cl. 347/86

(57) ABSTRACT

A refillable chemical cartridge includes a flexible, foldable non-metallized bag and a two-part refillable cartridge housing. The bag includes a fitment and a septum that allow the bag to be filled with a liquid chemical to a full volume and allow the liquid chemical to be removed from the bag. The two-part refillable cartridge housing includes a top half with a latch, a bottom half with a latch receptacle, a fitment locator, and a hinge. The hinge connects the bottom and top halves forming a closable, locking housing. The cartridge housing is adapted to hold the bag in a folded position in the closed housing.

### FIELD OF THE INVENTION

The present embodiments relate generally to a two-part refillable cartridge housing having a refillable bag for printers and printing systems.

### BACKGROUND OF THE INVENTION

Ink jet printers that use remotely located ink cartridges have the ability to use an increased volume of the ink without impacting the ability of the printhead carriage to perform print function during the printing process. Typically, the mass of the carriage supporting the printheads needs to be reduced so as to minimize the inertial load on the printhead carriage. The ink cartridge is located in an ink cartridge receiver assembly and can be coupled to a printhead via flexible tubing, a needle, and a septum interface. This ink delivery system must provide a barrier between the ink and the atmosphere due to the sensitivity of the piezoelectric printhead to dissolve or entrain gases in the ink.

The ink cartridges not on the printhead carriage are called off-axis cartridges. The off-axis cartridges are typically configured as a plastic or cardboard housing, including a flexible ink bag. The flexible ink bag allows the ink to be consumed without exposing it to air or creating a vacuum within the ink cartridge.

Known methods involve placing a flexible ink bag, as shown in U.S. Design Pat. No. D341,157, inside an assembled plastic ink cartridge housing and attaching the bag to the inside wall of the housing using double sided tape, as shown in U.S. Pat. No. 5,666,146. On the opposing side of the bag, a rigid plastic member is attached using double sided tape. This ink cartridge is loaded onto the machine in a horizontal fashion such that as the ink is removed from the cartridge at a pressure level within the bag the pressure does not change significantly. This housing is substantially larger than the volume of the ink bag and does not constrict the shape of the ink bag when the bag is full or at a level less than full. The tape and a rigid plastic member maintain a relative stiffness for the flexible bag suitable to keep the bag in a shape that evacuates properly. The drawback to this design is the housing and bag cannot be reused and, therefore, the entire unit must be thrown away.

A need exists for an environmentally friendly refillable ink cartridge that minimizes leaking of chemical liquids used in printers and photo processors. A need exists for a cartridge that contains a minimum number of pieces in order to be “landfill friendly”.

The present embodiments described herein were designed to meet these needs.

### SUMMARY OF THE INVENTION

A refillable liquid chemical cartridge includes a flexible, foldable non-metallized bag contained within a two-part refillable cartridge housing. The bag has an attached fitment and a septum that aid in filling and unloading liquid chemicals, and/or inks, from the bag. The bag is expandable to be larger than in the folded position. The bag holds a predetermined percentage volume of liquid chemicals less than the full volume. The cartridge housing is adapted to hold the bag in a folded position in a closed, locking housing. The cartridge housing includes two or more latches, a fitment locator, and one or more hinges to connect the two-part housing together. The hinge connects the top half and bottom half of the cartridge housing. The latches secure the cartridge housing in a closed position.

### BRIEF DESCRIPTION OF THE DRAWINGS

In the detailed description of the preferred embodiments presented below, reference is made to the accompanying drawings, in which:

FIG. 1 depicts a perspective view of an embodiment of the refillable chemical cartridge in an opening position.

FIG. 2 depicts a perspective view of an embodiment of the refillable chemical cartridge in a closed position.

FIG. 3 depicts a side view of an embodiment of bag with the fitment and septum.

The present embodiments are detailed below with reference to the listed Figures.

### DETAILED DESCRIPTION OF THE INVENTION

Before explaining the present embodiments in detail, it is to be understood that the embodiments are not limited to the particular descriptions and that it can be practiced or carried out in various ways.

The present embodiments provide an environmentally friendly chemical cartridge device that minimizes leaking of chemical liquids used in printers and photo processors, thereby providing flexibility to change chemicals or inks easily in the print system. The embodied refillable cartridges reduce waste by utilizing a two-part construction that enables a bag containing chemicals to be thrown away without throwing away the cartridge housing. The embodied cartridges are thereby “landfill friendly” since the cartridges reduce waste and can be recycled by the user on a daily or hourly basis.

The cartridge housing and bag combinations of the present embodiments provide a more compact cartridge for small footprint machines. The embodied cartridges provide a lower cost solution for printers in that new cartridges do not have to be purchased and can be reused until the plastic housing wears out.

The present embodiments provide an advantage in that different bag sizes and different cartridge sizes can be made and utilized as described herein. A variety of sizes and combinations can be created ranging from very large sizes of over 5 liters in capacity to the very small sizes of only 10 cubic inches of fluid volume, typically used for highly specialized portable printers.

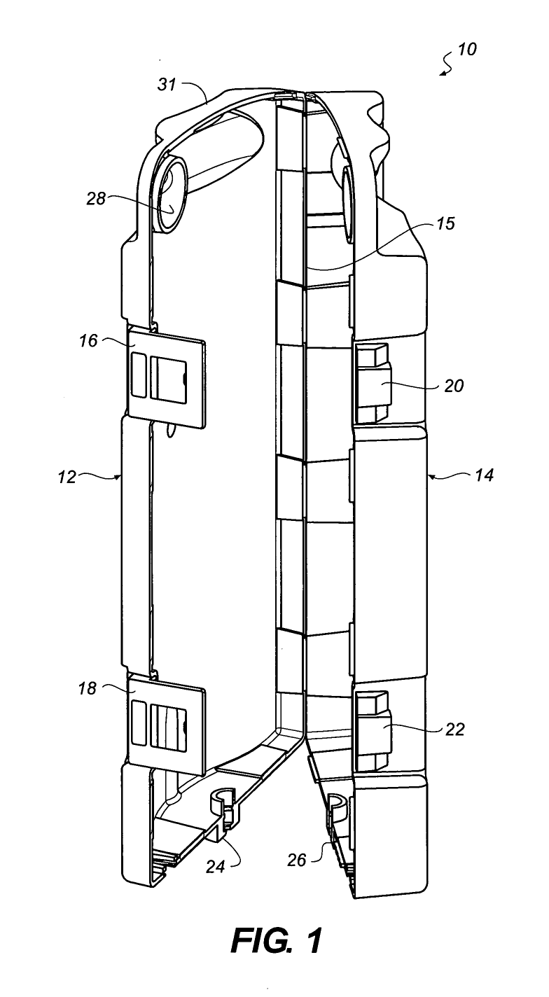

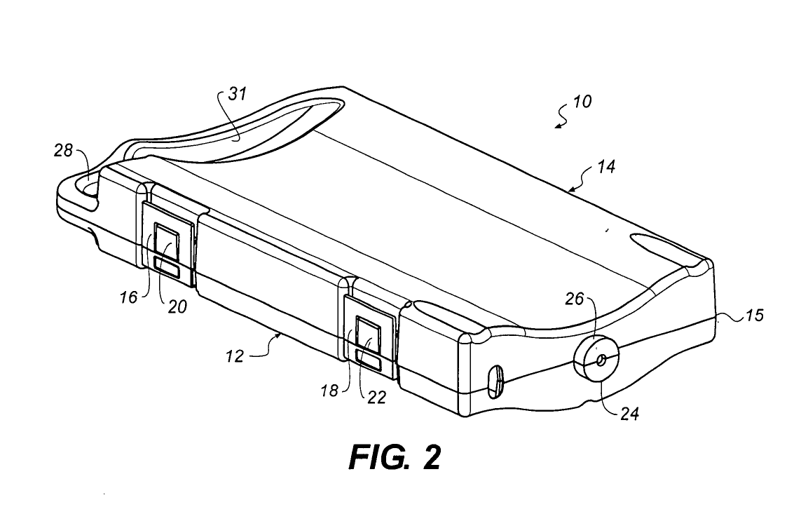

With reference to the figures, FIG. 1 and FIG. 2 depict an embodiment of the refillable chemical cartridge 10. FIG. 1 depicts the cartridge 10 in an open position and FIG. 2 depicts the cartridge 10 in the closed position. The cartridge 10 in the closed position holds a filled or partially filled bag.

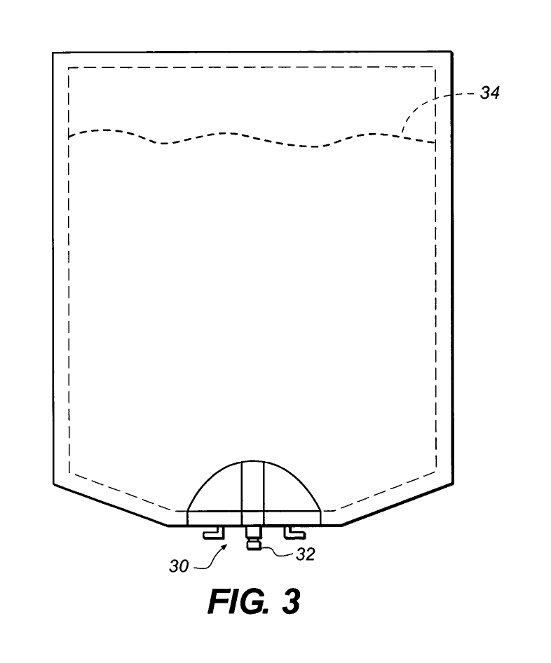

The bag is designed to hold a volume of a liquid chemical 34, such as bleach, developer, fixer, stabilizer, bleach fixer, and other similar useful photo processing chemicals. The bag has a fitment 30 and a septum 32, as depicted in FIG. 3. The fitment 30 and septum 32 aid in filling the bag with a liquid chemical, as well as aid in evacuating the liquid chemical from the bag.

The fitment 30 can be removed from the septum 32. Any residual air in the bag can be expelled through the fitment 30 by squeezing the bag to raise the liquid level in the bag at least into the port. The bag can then be partially collapsed to conform substantially to the volume of the liquid chemical 34 in the bag. By conserving the volume in the bag to only the actual volume of the liquid chemical 34, the bag can fit into the cartridge housing.

Preferably, the non-metallized bag is expandable to be larger in the unfolded position than in the folded position. The bag can hold a predetermined percentage of chemical liquid 34 while in the folded position. Typically, the predetermined percentage is from about 70% to about 95% of the full volume.

The typical bag used with the embodied cartridge holds between 0.5 liters and 1.5 liters of chemical fluid or ink, such as solvent-based inks, polymer-based inks, or aqueous-based inks. The bag can be made of a durable chemical resistant woven polymer or of a non-woven polymer with memory to return to a non-creased shape. The bag can be composed of a coated polymer, such as coated polypropylene/polyethylene film without metal.

The use of non-metallized bags has significant environmental benefits in that the non-metallized bags can degrade. In contrast, metallized bags do not degrade and remain in landfills for long periods of time. The embodied bag is folded widthwise along two opposite longitudinal edge portions that are folded from a longitudinal center portion between the longitudinal edge portions. Preferably, the folded bag has a width ranging between about 2% to about 5% of a total bag width. The longitudinal edge portions are typically each folded about 85 degrees to 95 degrees from the longitudinal center portion. Non-metallized bags reduce static charge incidences around chemicals. The reduction in static charge is helpful and is expected to reduce explosions and reduce maintenance problems.

Returning to FIG. 1 and FIG. 2, the embodied refillable chemical cartridge 10 includes a cartridge housing with a top part 12 and a bottom part 14. The top part 12 includes a first latch 16 and a fitment locator top half 24. The bottom part 14 includes a first latch receptacle 20 and a fitment locator bottom half 26. The cartridge housing can include more than one latch disposed in the top part 12 and more than one latch receptacle disposed in the bottom part 14. FIG. 1 and FIG. 2 depict an embodiment where the cartridge housing includes two latches 16 and 18 and two latch receptacles 20 and 22. Each latch connects to the respective latch receptacle forming a latched, locking housing. The top part 12 and bottom part 14 can have parallel curved surface. Curved parallel surfaces facilitate secure stacking, storage, and shipment of the cartridges. Alternatively, the top part 12 and bottom part 14 can include an indentation that acts as an easy grip handle when the housing is closed.

The top part 12 and the bottom part 14 are connected, typically by a hinge 15. The hinges allow the top part 12 and the bottom part 14 to be moved together into the closed position, as depicted in FIG. 2, and separated into the open position, as depicted in FIG. 1, while remaining attached together. The cartridge housing can include more than one hinge if necessary. The hinge 15 can be molded into the top part 12 and the bottom part 14. The hinge 15 can act as a shipping label.

While in the closed position, the cartridge housing is formed and shaped to contain the bag shape in a folded position.

The refillable chemical cartridge can include a finger port or a finger hole 28 for pulling the cartridge in and out of a device, such as a printer. The refillable chemical cartridge can include a handle 31.

The cartridge is prepared by initially providing a foldable bag, preferably non-metallized, with a fitment and a septum. The bag is filled to predetermined percentage volume with the liquid chemical. The predetermined percentage typically ranges from about 60% to about 75% of the full volume, preferably 65% of the full volume.

The bag is next folded and placed in the cartridge housing with the fitment between the fitment locator top and the fitment locator bottom. The housing is latched closed with the filled bag inside of the housing.

The cartridge is placed into a printer device, such as an ink jet printer, where the liquid chemical in the bag is pulled from the bag through the fitment and used by the device during operation. When the bag is depleted of the chemical liquid, the bag in the cartridge housing is replaced with a newly filled bag. Typically, the bag is replaced when the bag is less than 3% of the full volume of chemical.

The embodiments have been described in detail with particular reference to certain preferred embodiments thereof, but it will be understood that variations and modifications can be effected within the scope of the embodiments, especially to those skilled in the art.

### PARTS LIST

10. chemical refillable cartridge
12. top part of the two-part refillable cartridge
14. bottom part of the two-part refillable cartridge
15. hinge
16. first latch
18. second latch
20. first latch receptacle
22. second latch receptacle
24. top half of the fitment locator
26 bottom half of the fitment locator
28. finger port
30 fitment
31. handle
32. septum
34. liquid chemical

1. A refillable chemical cartridge comprising:
a. a flexible, foldable non-metallized bag comprising a fitment and a septum, wherein the fitment and the septum are adapted to fill the bag with a liquid chemical to a full volume and evacuate the liquid chemical from the bag; and
b. a two-part latching refillable cartridge housing adapted to contain an at least partially filled bag, wherein the housing comprises:
i. a top comprising a first latch and a fitment locator top half;
ii. a bottom comprising a first latch receptacle and a fitment locator bottom half;
iii. a hinge connecting the bottom and the top, wherein the first latch connects to the first latch receptacle forming a closed housing; and
wherein the bag is expandable to be larger than in a folded position, and wherein the bag is adapted to hold a predetermined percentage of fluid that is less than the full volume of the bag.

2. The cartridge of claim 1, wherein the bag is a durable chemical resistant polymer bag.

3. The cartridge of claim 1, wherein the bag is a non-woven polymer with memory to return to an non-creased shape.

4. The cartridge of claim 1, wherein the bag holds between 0.5 liters and 1.5 liters of chemical fluid.

5. The cartridge of claim 1, wherein the bag is a coated polymer

6. The cartridge of claim 1, wherein the liquid chemical is bleach, developer, fixer, stabilizer, bleach fixer, or photo processing chemicals.

7. The cartridge of claim 1, wherein the housing is comprises of a durable plastic.

8. The cartridge of claim 1, wherein the top and bottom each comprise a curved surface, and wherein the curved surfaces are parallel.

9. The cartridge of claim 1, wherein the top and bottom each comprise half of an indentation, wherein an easy grip handle is formed when the top and bottom are latched closed.

10. The cartridge of claim 1, wherein the hinge is molded into the top and the bottom.

11. The cartridge of claim 1, wherein the hinge is a shipping label.

12. The cartridge of claim 1, wherein the predetermined percentage ranges of chemical from about 70% to about 95% of the full volume.

13. The cartridge of claim 1, further comprising a finger port for pulling the cartridge in and out of a printer or film and paper minilab and kiosk.

14. The cartridge of claim 1, further comprising
a. at least a second latch disposed in the top; and
b. at least a second latch receptacle disposed in the bottom, wherein the at least second latch connects to the at least second latch receptacle forming the closed housing.

15. A method of preparing a chemical refillable cartridge, wherein the method comprises the steps of:
a. forming a partially filled foldable non-metallized bag with a fitment and a septum;
b. disposing the bag in a two-part refillable cartridge housing, wherein the cartridge housing comprises
i. a top comprising a first latch and a fitment locator top half;
ii. a bottom comprising a first latch receptacle and a fitment locator bottom half; and
iii. a hinge connecting the bottom and the top, wherein the first latch connects to the first latch receptacle forming a closed housing, wherein the cartridge housing is adapted to hold the bag in a folded position in the closed housing;
c. filling the fitment of the bag into the fitment locator of the cartridge housing;
d. folding the bag into the cartridge housing and latching the housing closed;
e. connecting the printing system to the fitment;
f. using the liquid chemical with the printing system and depleting the liquid chemical from the bag; and
g. replacing the bag with a new filled bag in the cartridge housing when liquid chemical in the bag is less than 3% of the full volume of the bag.

16. A non-metallized ink supply bag for a printing system partially filled with an ink, wherein the bag comprises a fitment and a septum on the same side, wherein the bag is partially filled to a predetermined percentage less than a full volume, and wherein the bag is folded widthwise along two opposite longitudinal edge portions that are folded from a longitudinal center portion between the longitudinal edge portions.

17. The bag of claim 16, wherein the longitudinal edge portions each comprise a width ranging between about 2% to about 5% of a total bag width, and wherein the longitudinal edge portions are each folded about 85 degrees to 95 degrees from the longitudinal center portion.
